(19) United States
(12) Patent Application Publication
(10) Pub. No.: US 2025/0260771 A1
(43) Pub. Date: Aug. 14, 2025

(54) COMMUNICATION APPARATUS AND CONTROL METHOD

(71) Applicant: CANON KABUSHIKI KAISHA, Tokyo (JP)

(72) Inventor: SHIEKA ARAI, Tokyo (JP)

(21) Appl. No.: 19/041,076

(22) Filed: Jan. 30, 2025

(30) Foreign Application Priority Data
Feb. 8, 2024 (JP) 2024-018023

(51) Int. Cl. H04N 1/00

(52) U.S. Cl. CPC H04N 1/00095

(57) ABSTRACT

A communication apparatus that is able to communicate with an external apparatus, includes a transfer unit that transfers contents to a transfer destination, an extraction unit that extracts a predetermined content having a largest data amount from the contents to be transferred, and a presentation unit that presents, before transferring the contents, a data amount after compression processing of the predetermined content.

### BACKGROUND OF THE INVENTION

### Field of the Invention

The present invention relates to a system in which an external apparatus and a communication apparatus are connected so as to be capable of mutual communication.

### Description of the Related Art

In recent years, in the mass media industry such as media companies and telecommunication companies, it is increasingly required to quickly deliver content such as an image and a sound shot in a reporting location, and there is provided a content transfer solution via various network communications. For example, as an application of a mobile device, there is provided a mobile application having a function of transmitting content such as a still image, a moving image, and a sound generated by an image capture apparatus to the mobile device such as a smartphone and transmitting the content from the mobile device to an external server via a network by a communication method such as File Transfer Protocol (FTP) (Transfer & Tagging (Sony Corporation) <URL: https://support.d-imaging.sony.co.jp/app/transfer/ja/>).

Since it is impossible to deliver content to a transfer destination such as a media company or a telecommunication company when the upper limit of a receivable data amount is exceeded, the file size of content to be delivered is designated. A transfer source such as a reporting location confirms the file size of content so as not to exceed the designated file size, and then delivers the content. In addition, the transfer source performs compression processing of content to reduce the file size of the content acquired from the image capture apparatus.

When a plurality of contents are compressed and transferred to the transfer destination, the transfer source confirms the file size of the contents after the compression processing and then transfers the contents so as not to exceed the upper limit of the data amount receivable by the transfer destination. When a file size after compression processing of a plurality of contents is calculated, it takes time to acquire the contents and perform the compression processing, and the file size after the compression processing is confirmed while adjusting the setting of the compression processing, thereby making it difficult to quickly deliver the contents.

In Transfer & Tagging, a file size after compression processing of a plurality of contents is calculated by using, as a reference value, a file size obtained in a case where one content randomly selected from the plurality of contents is compressed. However, if the file size of the randomly selected content is smaller than the size of an unselected content, the file size after the compression processing of the plurality of contents may exceed the upper limit of the data amount receivable by the transfer destination.

### SUMMARY OF THE INVENTION

The present invention has been made in consideration of the aforementioned problems, and realizes techniques of transferring content not to exceed the upper limit of a data amount receivable by a transfer destination.

In order to solve the aforementioned problems, the present invention provides a communication apparatus that is able to communicate with an external apparatus, comprising: a transfer unit that transfers contents to a transfer destination; an extraction unit that extracts a predetermined content having a largest data amount from the contents to be transferred; and a presentation unit that presents, before transferring the contents, a data amount after compression processing of the predetermined content.

In order to solve the aforementioned problems, the present invention provides a control method of a communication apparatus that transfers contents to a transfer destination, comprising: extracting a predetermined content having a largest data amount from the contents to be transferred; and presenting, before transferring the contents, a data amount after compression processing of the predetermined content.

According to the present invention, it is possible to transfer content not to exceed the upper limit of a data amount receivable by a transfer destination.

Further features of the present invention will become apparent from the following description of exemplary embodiments (with reference to the attached drawings).

### BRIEF DESCRIPTION OF THE DRAWINGS

FIG. 1 is a view illustrating a system configuration according to a present embodiment;

FIGS. 2A and 2B are a block diagram and a view illustrating the configuration of an image capture apparatus according to the present embodiment;

FIG. 3 is a block diagram illustrating the configuration of a communication apparatus according to the present embodiment;

FIGS. 4A to 4E are views each illustrating an application screen of the communication apparatus according to the present embodiment;

FIG. 5A is a flowchart illustrating control processing of the communication apparatus according to the present embodiment; and

FIG. 5B is a flowchart illustrating the control processing of the communication apparatus according to the present embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### System Configuration

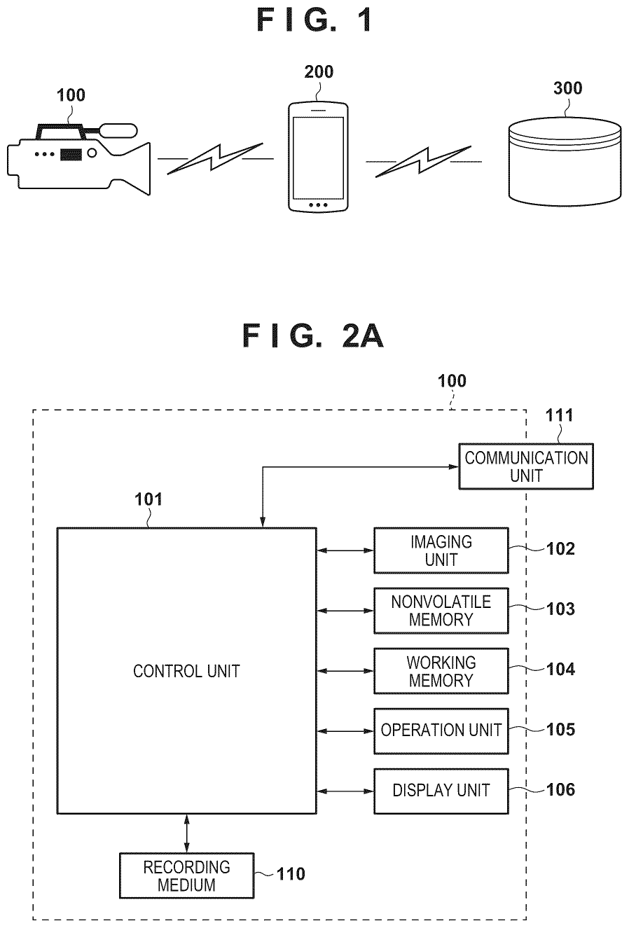

First, a system configuration according to a present embodiment will be described with reference to FIG. 1.

In a system according to the present embodiment, an image capture apparatus 100, a communication apparatus 200, and a content management apparatus 300 are connected so as to be capable of mutual communication.

The image capture apparatus 100 and the communication apparatus 200 are connected by a wireless antenna or a wired cable, and can communicate with each other by a wireless communication method or a wired communication method. The image capture apparatus 100 can transfer, to the communication apparatus 200, a moving image file generated by performing moving image shooting processing.

The communication apparatus 200 and the content management apparatus 300 are connected via a communication line such as mobile data communication, and it is possible to transfer an image file saved in the communication apparatus 200 to the content management apparatus 300.

The content management apparatus 300 is an apparatus that provides a service associated with content. The content management apparatus 300 is an FTP server that transmits/receives a file to/from an FTP client in accordance with

File Transfer Protocol (FTP). The communication apparatus 200 serves as an FTP client to be connected to the FTP server so as to be capable of mutual communication. Note that the communication protocol of the present embodiment is not limited to FTP and File Transfer Protocol over SSL/TLS (FTPS), SSH File Transfer Protocol (SFTP), or the like may be used.

Note that the system configuration of the present embodiment is merely an example and, for example, it may be configured to connect the image capture apparatus 100, the communication apparatus 200, and the content management apparatus 300 to the same network via an access point such as a wireless Local Area Network (LAN) and perform transfer processing of a file between the apparatuses.

### Apparatus Configuration

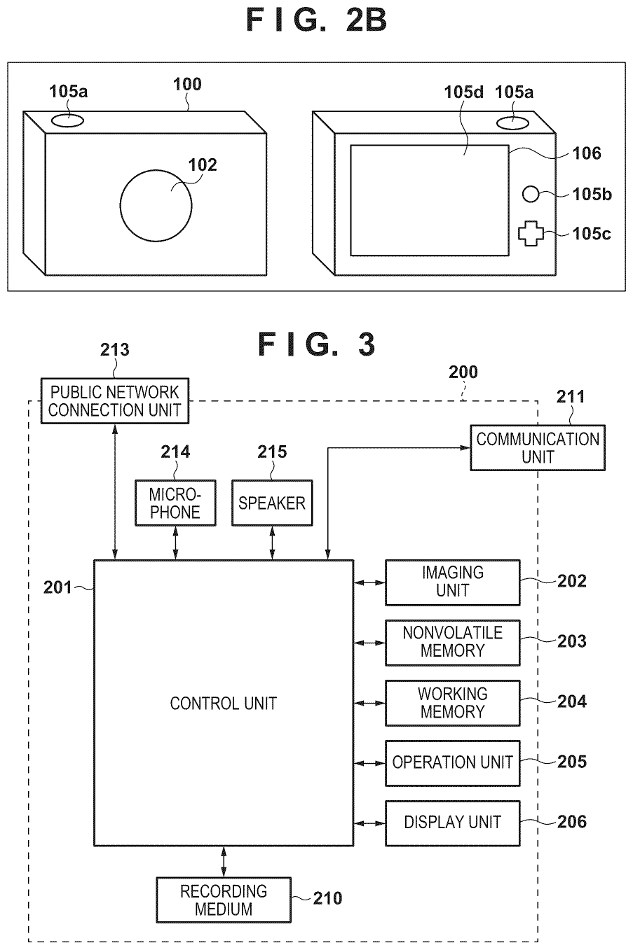

Next, the configuration and function of the image capture apparatus 100 according to the present embodiment will be described with reference to FIGS. 2A and 2B.

FIG. 2A is a block diagram illustrating the configuration of the image capture apparatus 100 according to the present embodiment.

The present embodiment will describe a case where the image capture apparatus is a digital video camera. However, the present invention is not limited to this, and the image capture apparatus may be an information processing apparatus having a camera function and a communication function, such as a tablet computer or a personal computer, a media player, a monitoring camera, a medical camera, or the like. The image capture apparatus 100 may be a device that records, reproduces, or edits a video.

A control unit 101 is a Central Processing Unit (CPU) that comprehensively controls the overall image capture apparatus 100, and implements communication processing and control processing to be described later by executing programs stored in a nonvolatile memory 103 to be described later. Note that a plurality of hardware components may control the overall apparatus by sharing processing, instead of controlling the overall apparatus by the control unit 101.

An imaging unit 102 includes a lens group including a zoom lens and a focus lens, and a shutter having an aperture function. Furthermore, the imaging unit 102 includes an image sensor formed by a CCD or CMOS element that converts an object image into an electrical signal, and an A/D converter that converts an analog image signal output from the image sensor into a digital signal. Under the control of the control unit 101, the imaging unit 102 converts object image light whose image is formed by the lenses included in the imaging unit 102 into an electrical signal by the image sensor, performs noise reduction processing or the like, and outputs image data formed by a digital signal.

The control unit 101 performs resize processing such as pixel interpolation and reduction or color conversion processing for the image data captured by the imaging unit 102. Furthermore, the control unit 101 performs compression coding using the JPEG format or the like for still image data that has undergone image processing, or encodes moving image data by a moving image compression method such as the MP4 format, thereby generating an image file and recording it in a recording medium 110. In the image capture apparatus 100 of the present embodiment, the image data is recorded in the recording medium 110 in accordance with the Design Rule for Camera File system (DCF) standard. In addition, the control unit 101 performs predetermined arithmetic processing using captured image data, and controls the focus lens, the aperture, and the shutter of the imaging unit 102 based on the obtained arithmetic result, thereby performing auto-focus (AF) processing or auto-exposure (AE) processing.

The nonvolatile memory 103 is an electrically erasable/recordable memory and, for example, an EEPROM or the like is used. The nonvolatile memory 103 records constants, programs, and the like for the operation of the control unit 101. The programs are programs for executing communication processing and control processing to be described later in the present embodiment.

A working memory 104 is used as a work area in which constants and variables for the operation of the control unit 101, and programs and the like read out from the nonvolatile memory 103 are deployed. In addition, the working memory 104 is used as a buffer memory that temporarily holds image data captured by the imaging unit 102 or an image display memory for a display unit 106.

An operation unit 105 is formed by operation members such as various kinds of switches, buttons, and a touch panel that accept various kinds of operations from the user. As shown in FIG. 2B, the operation unit 105 includes, for example, a shutter-release button 105a used to shoot an image, a reproduction button 105b used to reproduce a shot image, and a cross key 105c that is formed from up, down, left, and right buttons for making various settings of a camera. The operation unit 105 also includes a touch panel 105d formed integrally with the display unit 106 to be described later. Furthermore, the operation unit 105 includes an operation member such as a dedicated connection button used to start communication with an external apparatus via a communication unit 111 to be described later.

The display unit 106 displays a viewfinder image at the time of shooting, a shot image, characters for interactive operations, and the like. The display unit 106 is, for example, a display device such as a liquid crystal display or an organic EL display. The display unit 106 may be integrated with the image capture apparatus 100 or may be an external apparatus connected to the image capture apparatus 100. The image capture apparatus 100 can be connected to the display unit 106, and need only have a function of controlling display of the display unit

The recording medium 110 records image data output from the imaging unit 102. Furthermore, the control unit 101 reads out an image file saved in the recording medium 110 in a reproduction mode. The recording medium 110 may be a memory card, a hard disk drive, or the like attached to the image capture apparatus 100, or a flash memory or a hard disk drive incorporated in the image capture apparatus 100. The image capture apparatus 100 need only have at least a function for accessing the recording medium 110.

The communication unit 111 serves as an interface for performing connection to an external apparatus such as the communication apparatus 200. The image capture apparatus 100 according to the present embodiment can exchange data with the external apparatus via the communication unit 111. For example, the image capture apparatus 100 can transmit, to the external apparatus via the communication unit 111, image data generated by the imaging unit 102. Note that in the present embodiment, the communication unit 111 includes an interface for communicating with the external apparatus by a wireless LAN complying with the IEEE802.11 standard. The control unit 101 implements wireless communication with the external apparatus by controlling the communication unit 111. Note that the communication method is not limited to the wireless LAN and can include, for example, a wireless communication interface such as an infrared communication interface or Wireless USB and a wired communication interface such as a USB cable, HDMI®, or IEEE1394.

Note that the communication unit 111 of the image capture apparatus 100 according to the present embodiment has an AP mode of operating as an access point in an infrastructure mode, and a CL mode of operating as a client in the infrastructure mode. Then, by making the communication unit 111 operate in the

CL mode, the image capture apparatus 100 according to the present embodiment can operate as a CL apparatus in the infrastructure mode. When the image capture apparatus 100 operates as a CL apparatus, it can be connected to a peripheral AP apparatus to join a network formed by the AP apparatus. By making the communication unit 111 operate in the AP mode, the image capture apparatus 100 according to the present embodiment can operate as a simple AP whose function is limited, which is a kind of AP. When the image capture apparatus 100 operates as a simple AP, the image capture apparatus 100 forms a network by itself. An apparatus around the image capture apparatus 100 recognizes the image capture apparatus 100 as an AP apparatus, and can join the network formed by the image capture apparatus 100. A program for operating the image capture apparatus 100 is held in the nonvolatile memory 103, as described above.

Note that the image capture apparatus 100 according to the present embodiment is a kind of AP but is a simple AP that does not have a gateway function of transferring data received from the CL apparatus to an Internet provider or the like. Therefore, even if the image capture apparatus 100 receives data from another apparatus that joins the network formed by itself, it cannot transfer the data to a network such as the Internet.

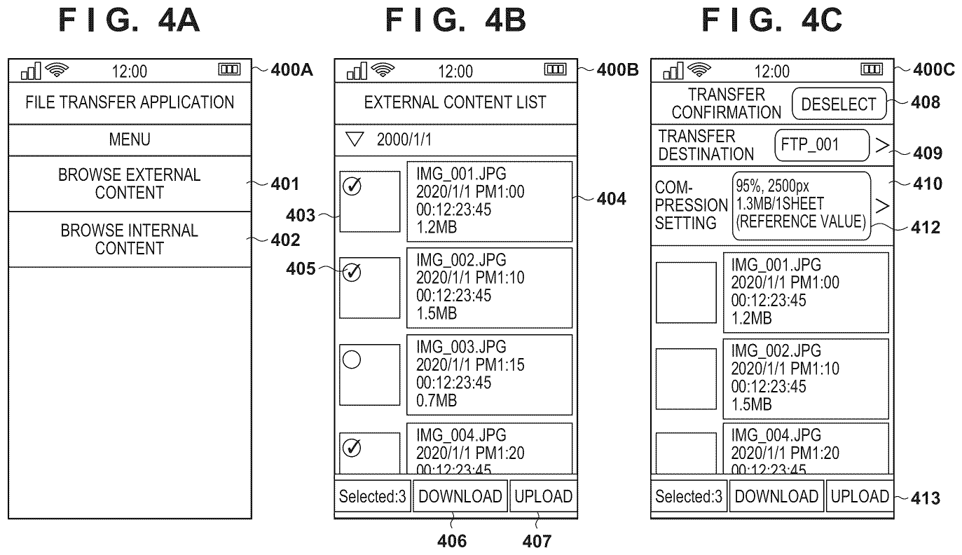

Next, the configuration and function of the communication apparatus 200 according to the present embodiment will be described with reference to FIG. 3.

The present embodiment will describe a case where the communication apparatus is a mobile device such as a smartphone or a tablet computer. However, the present invention is not limited to this, and the communication apparatus may be a digital camera having a communication function, a tablet computer, a personal computer, a wearable computer such as a wristwatch-type smartwatch or glass-type smartglasses, or the like.

The communication apparatus 200 according to the present embodiment includes a control unit 201, an imaging unit 202, a nonvolatile memory 203, a working memory 204, an operation unit 205, a display unit 206, a recording medium 210, and a communication unit 211. The basic functions of these elements are the same as those of the image capture apparatus 100 and a detailed description thereof will be omitted.

The nonvolatile memory 203 stores an Operating System (OS) as basic software to be executed by the control unit 201, and applications for realizing appliable functions in cooperation with the OS. The nonvolatile memory 203 stores an application for communicating with the image capture apparatus 100 and the content management apparatus 300. The nonvolatile memory 203 stores a file transfer application for communicating with the image capture apparatus 100 and the content management apparatus 300. The nonvolatile memory 203 stores an application for saving an image file such as still image data or moving image data acquired from the image capture apparatus 100 and managing it.

The processing of the communication apparatus 200 according to the present embodiment is implemented by loading software provided by the application. Note that the application includes software for using the basic functions of the OS installed in the communication apparatus 200. Note that the OS of the communication apparatus 200 may include software for implementing the processing according to the present embodiment.

The communication unit 211 includes a wireless communication interface for wirelessly communicating with an external apparatus such as the image capture apparatus 100 or the content management apparatus 300. The control unit 201 implements wireless communication with the external apparatus by controlling the communication unit 211. Note that the communication unit 211 may be connected to the image capture apparatus 100 or the content management apparatus 300 directly or via an access point. As a protocol for communicating data, for example, Picture Transfer Protocol over Internet Protocol (PTP/IP) via a wireless LAN can be used. Note that communication with the image capture apparatus 100 or the content management apparatus 300 is not limited to this. For example, the communication unit 211 can include an infrared communication module, a Bluetooth® communication module, and a wireless communication module such as Wireless USB. Furthermore, a wired connection interface such as a USB cable, HDMI®, or IEEE1394 may be used.

A public network connection unit 213 is an interface used to perform wireless communication via a Wide Area Network (WAN) such as 4G/LTE or 5G. The communication apparatus 200 can perform a telephone call and data communication with another device via the public network connection unit 213. When performing a telephone call, the control unit 201 inputs and outputs sound signals via a microphone 214 and a loudspeaker 215. In present embodiment, the public network connection unit 213 is not limited to 4G/LTE or 5G and another communication method such as local 5G, WiMAX, ADSL or FTTH may be used. In the present embodiment, the public network connection unit 213 serves as an antenna, and the control unit 201 can be connected to the public network via the antenna. Note that one antenna can serve as the communication unit 211 and the public network connection unit 213. Note that the communication unit 211 and the public network connection unit 213 need not be implemented by independent hardware components and, for example, one antenna can serve as these units.

Note that since the communication speed of communication implemented by the communication unit 211 is higher than that of communication implemented by the public network connection unit 213, the communication apparatus 200 of the present embodiment preferentially performs communication via the communication unit 211 in a state in which no telephone call is performed with another device via the public network connection unit 213.

### Control Processing

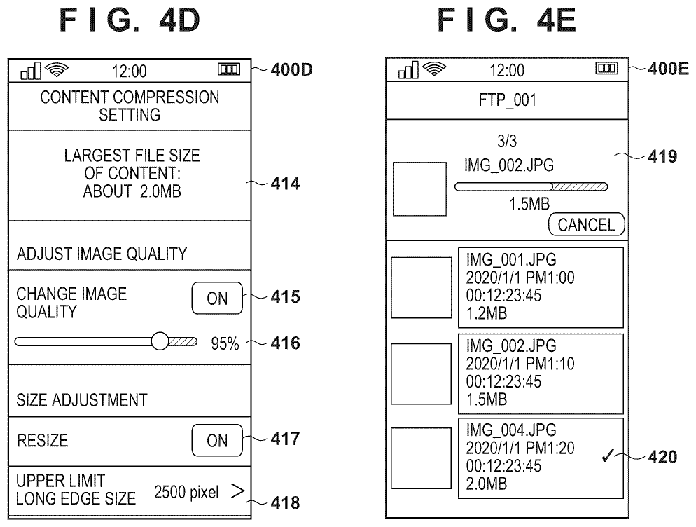

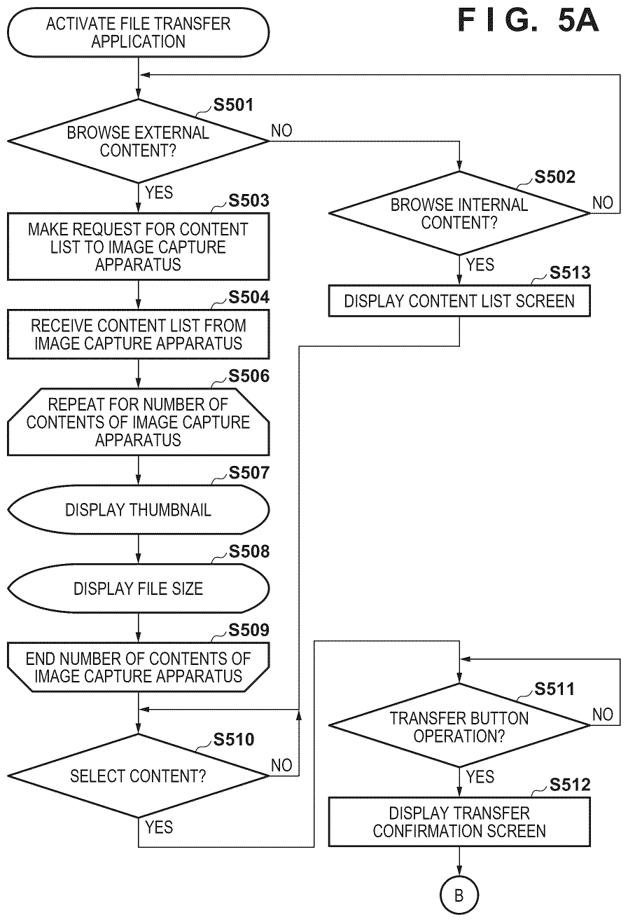

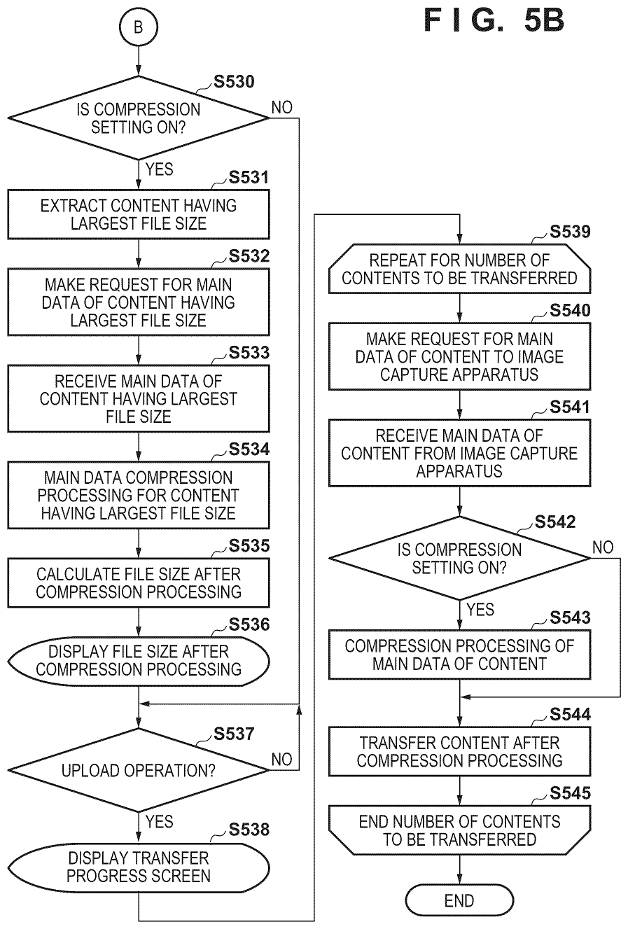

Next, the control processing of the communication apparatus 200 according to the present embodiment will be described with reference to FIGS. 4A to 4E, 5A, and 5B.

The present embodiment will describe an example in which content is an image file, but the content is not limited to the image file and may be a sound file or the like.

FIGS. 4A to 4E each illustrates an application screen for implementing the control processing of the communication apparatus 200 according to the present embodiment. FIGS. 5A and 5B are flowcharts illustrating the control processing of the communication apparatus 200.

The processing shown in FIGS. 5A and 5B is implemented when the control unit 201 of the communication apparatus 200 deploys a program of an application (or the function of the application, the OS or, the service of the OS) stored in the nonvolatile memory 203 to the working memory 204 and executes it. The processing shown in FIGS. 5A and 5B is started when the file transfer application for implementing the control processing of the communication apparatus 200 according to the present embodiment is activated to display an application screen 400A shown in FIG. 4A on the display unit 206 and the user operates the operation unit 205 to select, as a trigger, an external content browsing menu 401 or an internal content browsing menu 402 of the application screen 400A shown in FIG. 4A.

In step S501, the control unit 201 determines whether the user operates the operation unit 205 to select the external content browsing menu 401 of the application screen 400A shown in FIG. 4A. The user can browse a list of contents held by the image capture apparatus 100 by selecting the external content browsing menu 401 of the application screen 400A shown in FIG. 4A. When the control unit 201 determines that the external content browsing menu 401 of the application screen 400A shown in FIG. 4A is selected, the process advances to step S503. When the control unit 201 determines that the external content browsing menu 401 of the application screen 400A shown in FIG. 4A is not selected, the process advances to step S502.

In step S503, the control unit 201 transmits, to the image capture apparatus 100, an acquisition request of the list of the contents held by the image capture apparatus 100.

In step S504, the control unit 201 receives the content list from the image capture apparatus 100, and saves it in the working memory 204. The content list does not include main data of the content having a large file size (data amount or data size), for which it takes time to receive and display, and includes only supplementary information of the content. In a case where the content is an image file, the supplementary information corresponds to a header portion including file information, and the main data corresponds to a data portion including image data (pixel values and the like). The supplementary information of the content includes minimum information such as a thumbnail obtained by reducing the main data, a file name, a shooting date/time, and a file size.

Processing in steps S506 to S509 are processing of displaying a list of pieces of supplementary information of the content list acquired from the image capture apparatus 100 in step S504, and are repeated the number of times equal to the number of contents held by the image capture apparatus 100.

In steps S507 and S508, the control unit 201 displays a content list screen 400B shown in FIG. 4B on the display unit 206. On the content list screen 400B shown in FIG. 4B, a thumbnail image 403 and supplementary information 404 included in the content list received in step S504 are displayed.

When the processing in steps S507 and S508 are repeated the number of times equal to the number of contents, the process advances to step S510.

In step S510, the control unit 201 determines whether the user operates the operation unit 205 to select a check button 405 on the content list screen 400B shown in FIG. 4B. When the control unit 201 determines that the check button 405 on the content list screen 400B shown in FIG. 4B is selected, the process advances to step S511. When the control unit 201 determines that no check button 405 on the content list screen 400B shown in FIG. 4B is selected, the process returns to step S510.

In step S511, the control unit 201 determines whether the user operates the operation unit 205 to select a transfer button 406 or 407 on the content list screen 400B shown in FIG. 4B. The user can download the content held by the image capture apparatus 100 to the communication apparatus 200 by selecting the download button 406 on the content list screen 400B shown in FIG. 4B. In addition, the user can upload the content held by the image capture apparatus 100 or the communication apparatus 200 to the content management apparatus 300 by selecting the upload button 407 on the content list screen 400B shown in FIG. 4B. When the control unit 201 determines that the transfer button 406 or 407 on the content list screen 400B shown in FIG. 4B is selected, the process advances to step S512. When the control unit 201 determines that the transfer button 406 or 407 on the content list screen 400B shown in FIG. 4B is not selected, the process returns to step S511.

In step S502, the control unit 201 determines whether the user operates the operation unit 205 to select the internal content browsing menu 402 of the application screen 400A shown in FIG. 4A. The user can browse a list of contents held by the communication apparatus 200 by selecting the internal content browsing menu 402 of the application screen 400A shown in FIG. 4A. When the control unit 201 determines that the internal content browsing menu 402 of the application screen 400A shown in FIG. 4A is selected, the process advances to step S513. When the control unit 201 determines that the internal content browsing menu 402 of the application screen 400A shown in FIG. 4A is not selected, the process returns to step S501.

In step S513, the control unit 201 displays the thumbnail images 403 and the pieces of supplementary information 404 of the contents held by the communication apparatus 200 on the content list screen 400B shown in FIG. 4B, and advances the process to step S510.

In step S512, the control unit 201 displays a transfer confirmation screen 400C shown in FIG. 4C on the display unit 206. A deselect button 408 shown in FIG. 4C is displayed on the transfer confirmation screen 400C, and if the user operates the operation unit 205 to select the deselect button 408, he/she can reselect contents to be transferred. In a case that the user operates the operation unit 205 to select a transfer destination menu 409 of the transfer confirmation screen 400C shown in FIG. 4C, he/she can set the transfer destination of the contents. In a case that the user operates the operation unit 205 to select a compression setting menu 410 of the transfer confirmation screen 400C shown in FIG. 4C, a content compression setting screen 400D shown in FIG. 4D is displayed, and the user can perform setting of compression processing of the contents to be transferred. In a case that the user turns on an image quality adjustment button 415 on the content compression setting screen 400D shown in FIG. 4D, an image quality adjustment function is enabled to allow the user to set image quality 416. In a case that the user turns on a size adjustment button 417 on the content compression setting screen 400D shown in FIG. 4D, a size adjustment function is enabled to allow the user to set a content size 418. In addition, on the content compression setting screen 400D shown in FIG. 4D, a file size 414 in a case where the image quality 416 and the content size 418 set by the user are applied to perform compression processing of content having a largest file size is displayed. The user can perform compression setting of the contents to be transferred while confirming the file size 414 of the content having the largest file size, obtained after the compression processing. In the compression setting menu 410 of the transfer confirmation screen 400C shown in FIG. 4C, setting contents 412 of the compression processing set on the content compression setting screen 400D shown in FIG. 4D and the file size 414 of the content having the largest file size, obtained after performing the compression processing with the setting contents, are displayed. The user can confirm, in the compression setting menu 410 of the transfer confirmation screen 400C shown in FIG. 4C, the file size 414 of the content having the largest file size, obtained after performing the compression processing with the current compression settings.

In step S530, the control unit 201 determines whether the image quality adjustment button 415 on the content compression setting screen 400D shown in FIG. 4D is ON or the size adjustment button 417 is ON. When the control unit 201 determines that the image quality adjustment button 415 on the content compression setting screen 400D shown in FIG. 4D is ON or the size adjustment button 417 is ON, the process advances to step S531. When the control unit 201 determines that the image quality adjustment button 415 on the content compression setting screen 400D shown in FIG. 4D is not ON or the size adjustment button 417 is not ON, the process advances to step S537.

In step S531, the control unit 201 extracts the content having the largest file size from the selected contents.

In step S532, the control unit 201 transmits an acquisition request of the main data of the content having the largest file size to the image capture apparatus 100.

In step S533, the control unit 201 receives the main data of the content having the largest file size from the image capture apparatus 100, and saves it in the working memory 204.

In step S534, the control unit 201 executes compression processing of the main data of the content having the largest file size received from the image capture apparatus 100 in step S533. As the settings of the compression processing, the image quality 416 and/or the content size 418 set by the user on the content compression setting screen 400D shown in FIG. 4D are applied.

In step S535, the control unit 201 calculates the file size of the content having the largest file size, obtained after the compression processing in step S534.

In step S536, the control unit 201 displays, in the compression setting menu 410 of the transfer confirmation screen 400C shown in FIG. 4C, as a reference value, the file size 414 of the content having the largest file size after the compression processing, which has been calculated in step S535. By calculating the file size of the content having the largest file size after the compression processing and presenting it to the user before transferring the content, as described above, the user can confirm, at the time of transferring the contents, whether the upper limit (to be referred to as the limited data amount hereinafter) receivable by the content management apparatus 300 is exceeded. In addition, by actually performing the compression processing of the content and calculating the file size, the user can be notified of the correct file size that is not an estimated file size. In a case that, after calculating the file size obtained after the compression processing of the content having the largest file size, the user changes the compression settings or changes the contents to be transferred, the processing in steps S530 to S536 are re-executed to allow the user to always confirm the file size obtained after performing the compression processing of the content having the largest file size.

Note that in step S535, the file size calculation processing may be performed as follows.
The file size of the content having the largest file size is calculated for each of the file formats of the contents.
The file size is not calculated when the contents to be transferred are not selected in step S510.
A state in which the file size is being calculated is displayed.
The file size is calculated immediately before the content transfer processing in steps S539 to S544.
The file size is recalculated when the selection is switched between the external content browsing menu and the internal content browsing menu.
The file size is recalculated when the content list screen is switched by a filter function or the like.
The file size is recalculated at the time of connection to the image capture apparatus when all the contents held by the image capture apparatus are transferred.
The file size is recalculated every time the contents to be transferred are selected.

In step S537, the control unit 201 determines whether the user operates the operation unit 205 to select an upload button 413 on the transfer confirmation screen 400C shown in FIG. 4C. When the control unit 201 determines that the upload button 413 on the transfer confirmation screen 400C shown in FIG. 4C is selected, the process advances to step S538. When the control unit 201 determines that the upload button 413 on the transfer confirmation screen 400C shown in FIG. 4C is not selected, the process returns to step S537.

In step S538, the control unit 201 displays a transfer progress screen 400E shown in FIG. 4E on the display unit 206.

Processing in steps S539 to S545 are processing of transferring the contents selected in step S510 to the content management apparatus 300, and are repeated the number of times equal to the number of selected contents.

In step S540, the control unit 201 transmits an acquisition request of the main data of the content to the image capture apparatus 100.

In step S541, the control unit 201 receives the main data of the content from the image capture apparatus 100, and saves it in the working memory 204. In this case, it is unnecessary to receive the main data of the received content from the image capture apparatus 100 to calculate the file size.

In step S542, the control unit 201 determines whether the image quality adjustment button 415 on the content compression setting screen 400D shown in FIG. 4D is ON or the size adjustment button 417 is ON. When the control unit 201 determines that the image quality adjustment button 415 on the content compression setting screen 400D shown in FIG. 4D is ON or the size adjustment button 417 is ON, the process advances to step S543. When the control unit 201 determines that the image quality adjustment button 415 on the content compression setting screen 400D shown in FIG. 4D is not ON or the size adjustment button 417 is not ON, the process advances to step S544.

In step S543, the control unit 201 performs compression processing of the main data of the content received from the image capture apparatus 100 in step S541.

In step S544, the control unit 201 transfers the main data of the content after the compression processing in step S543 and all contents including the supplementary information of the content to the content management apparatus 300. While the content is transferred, a transfer status 419 is displayed on the transfer progress screen 400E shown in FIG. 4E. Since the compression processing of the content in steps S542 and S543 can be executed after the main data of the content is received, the processing order is not limited to that shown in FIG. 5B and may be changed.

After the processing in steps S539 to S545 are repeated the number of times equal to the number of contents, the control unit 201 ends the processing.

Note that when the internal content browsing menu 402 of the application screen 400A shown in FIG. 4A is selected in step S502, after the contents to be transferred are selected in step S513 on the content list screen 400B shown in FIG. 4B, and the content transfer confirmation screen 400C is displayed in step S512, the compression processing (step S543) of the content and the transfer processing (step S544) of the content after the compression processing are repeatedly executed in steps S539 to S545 the number of times equal to the number of contents to be transferred without executing the processing (steps S532, S533, S540, and S541) of receiving the main data of the content from the image capture apparatus 100.

According to the present embodiment, before transferring contents, the file size of the content having the largest file size after compression processing is calculated and presented to the user. As a result, the user can adjust the settings of the compression processing and the number of contents to be transferred while confirming whether the limited data amount of the content management apparatus 300 is exceeded, before transferring the contents. Therefore, it is possible to avoid a situation in which the limited data amount of the content management apparatus 300 is exceeded to make it impossible to transfer contents. Furthermore, by actually performing the compression processing of the content having the largest file size and calculating the file size, the user can be notified of the correct file size that is not an estimated file size.

### Other Embodiments

The present invention may be applied to a system formed by a plurality of devices (a host computer, an interface device, an image capture apparatus, a WEB application, and the like) or an apparatus formed by a single device.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-018023, filed Feb. 8, 2024 which is hereby incorporated by reference herein in its entirety.

What is claimed is:

1. A communication apparatus that is able to communicate with an external apparatus, comprising:
a transfer unit that transfers contents to a transfer destination;
an extraction unit that extracts a predetermined content having a largest data amount from the contents to be transferred; and
a presentation unit that presents, before transferring the contents, a data amount after compression processing of the predetermined content.

2. The communication apparatus according to claim 1, further comprising:
an acquisition unit that acquires data obtained by reducing content and supplementary information including a data amount of the content;
a display unit that displays the supplementary information; and
a selection unit that selects the contents to be transferred from contents displayed by the display unit.

3. The communication apparatus according to claim 2, wherein
the content is content held by the external apparatus, and
the acquisition unit acquires the supplementary information from the external apparatus.

4. The communication apparatus according to claim 2, wherein
the content is content held by the communication apparatus, and
the acquisition unit acquires supplementary information of the content held by the communication apparatus.

5. The communication apparatus according to claim 2, further comprising:
a compression processing unit that performs compression processing of the contents to be transferred; and
a calculation unit that calculates a data amount after the compression processing of the contents to be transferred.

6. The communication apparatus according to claim 5, further comprising:
a setting unit that performs setting of the compression processing,
wherein the calculation unit calculates the data amount after performing the compression processing by applying the setting of the compression processing.

7. The communication apparatus according to claim 6, wherein
the compression processing unit performs compression processing of main data of the predetermined content, and
the calculation unit calculates a data mount after the compression processing of the main data of the predetermined content.

8. The communication apparatus according to claim 7, wherein the predetermined content is content received from the external apparatus.

9. The communication apparatus according to claim 7, wherein
the predetermined content is content held by the communication apparatus.

10. The communication apparatus according to claim 7, wherein
the calculation unit calculates the data amount after the compression processing of the main data of the predetermined content for each of file formats of the contents to be transferred.

11. The communication apparatus according to claim 7, wherein
in a case where the selection unit does not select the contents to be transferred, the calculation unit does not calculate the data amount after the compression processing of the main data of the predetermined content.

12. The communication apparatus according to claim 7, wherein
the display unit displays a state in which the calculation unit is calculating the data amount after the compression processing of the main data of the predetermined content.

13. The communication apparatus according to claim 7, wherein
immediately before the transfer unit performs the transfer processing of the contents, the calculation unit calculates the data amount after the compression processing of the main data of the predetermined content.

14. The communication apparatus according to claim 7, wherein
in a case where the setting unit changes the compression setting of the compression processing, the calculation unit calculates the data amount after the compression processing of the main data of the predetermined content.

15. The communication apparatus according to claim 7, wherein
in a case where the contents to be transferred are changed, the calculation unit calculates the data amount after the compression processing of the main data of the predetermined content.

16. The communication apparatus according to claim 7, wherein
in a case where the contents displayed by the display unit are switched, the calculation unit calculates the data amount after the compression processing of the main data of the predetermined content.

17. The communication apparatus according to claim 7, wherein
in a case where all contents held by the external apparatus are transferred, the calculation unit calculates, at the time of connection to the external apparatus, the data amount after the compression processing of the main data of the predetermined content.

18. The communication apparatus according to claim 7, wherein
every time the selection unit selects the contents to be transferred, the calculation unit calculates the data amount after the compression processing of the main data of the predetermined content.

19. The communication apparatus according to claim 5, wherein
the compression processing unit performs the compression processing of main data of the contents to be transferred, which have been received from the external apparatus, and
the transfer unit transfers, to the transfer destination, the contents obtained after the compression processing.

20. The communication apparatus according to claim 19, further comprising:
a reception unit that receives, from the external apparatus, main data of the contents except for the predetermined content among the contents to be transferred.

21. The communication apparatus according to claim 5, wherein
the compression processing unit performs the compression processing of main data of the contents to be transferred among contents held by the communication apparatus, and
the transfer unit transfers the contents obtained after the compression processing.

22. The communication apparatus according to claim 3, wherein
the external apparatus is an image capture apparatus.

23. The communication apparatus according to claim 1, wherein
the content is an image.

24. A control method of a communication apparatus that transfers contents to a transfer destination, comprising:
extracting a predetermined content having a largest data amount from the contents to be transferred; and
presenting, before transferring the contents, a data amount after compression processing of the predetermined content.

25. A non-transitory computer-readable storage medium storing a program for causing a computer to function as a communication apparatus that is able to communicate with an external apparatus, comprising:
a transfer unit that transfers contents to a transfer destination;
an extraction unit that extracts a predetermined content having a largest data amount from the contents to be transferred; and
a presentation unit that presents, before transferring the contents, a data amount after compression processing of the predetermined content.
